(19) United States
(12) Patent Application Publication
(10) Pub. No.: US 2025/0266939 A1
(43) Pub. Date: Aug. 21, 2025

(54) COMMUNICATION METHOD AND RELATED APPARATUS

(71) Applicant: HUAWEI TECHNOLOGIES CO., LTD., Shenzhen (CN)

(72) Inventors: Na GAO, Shanghai (CN); Ting WANG, Shanghai (CN); Hao TANG, Shanghai (CN); Jianglei MA, Ottawa (CA)

(73) Assignee: HUAWEI TECHNOLOGIES CO., LTD., Shenzhen (CN)

(21) Appl. No.: 19/196,005

(22) Filed: May 1, 2025

Related U.S. Application Data
(63) Continuation of application No. PCT/CN2022/129347, filed on Nov. 2, 2022.

(51) Int. Cl. H04L 5/00; H04L 1/00; H04L 27/26

(52) U.S. Cl. CPC H04L 5/0001; H04L 1/0067; H04L 27/2627

(57) ABSTRACT

This application provides a communication method and a related apparatus. In the method, a first communication device determines a first target transport block TB, where the first target TB includes at least one modulation symbol, the at least one modulation symbol is obtained by modulating one bit group by using a first modulation scheme, the one bit group includes at least one bit of each of at least two first code blocks CBs, and the at least two first CBs are determined based on a to-be-transmitted TB. The first communication device sends the first target TB to a second communication device, and correspondingly, the second communication device receives the first target TB and demodulates the first target TB.

### CROSS-REFERENCE TO RELATED APPLICATIONS

This application is a continuation of International Application No. PCT/CN2022/129347, filed on Nov. 2, 2022, the disclosure of which is hereby incorporated by reference in its entirety.

### TECHNICAL FIELD

This application relates to the field of communication technologies, and in particular, to a communication method and a related apparatus.

### BACKGROUND

Ultra-reliable and low-latency communication (ultra-reliability low latency communication, URLLC) is one of three application scenarios of a fifth generation mobile communication technology (5th generation mobile communication technology, 5G), and is characterized by a low latency and high reliability. Therefore, in a URLLC scenario, there are high requirements on both a latency and reliability. Communication technologies evolved after 5G, such as the 6th generation mobile communication technology (6th generation mobile communication technology, 6G), will accelerate comprehensive digital transformation of vertical industries. As one of key 6G technologies, URLLC faces high requirements on a latency and reliability, to adapt to various vertical applications.

In a communication system, data transmission reliability may be improved in a data retransmission manner. However, a solution in which retransmission is performed based on an acknowledgement (acknowledge, ACK)/a negative acknowledgement (negative acknowledgement, NACK) fed back by a receive end cannot meet a latency requirement of a communication system. Therefore, a blind retransmission solution is proposed. To be specific, a transmit end directly retransmits a data packet without waiting for ACK/NACK feedback information from the receive end. Although this retransmission manner can resolve a transmission delay problem, a gain brought by repeated transmission of same data is limited.

Therefore, a retransmission solution is urgently needed to reduce a delay and improve data demodulation performance.

### SUMMARY

This application provides a communication method and a related apparatus, to reduce a delay and improve data demodulation performance.

According to a first aspect, a communication method is provided. The method may be performed by a first communication device, may be performed by a component (for example, a chip or a chip system) configured in the first communication device, or may be implemented by a logical module or software that can implement all or some functions of the first communication device. This is not limited in this application.

The method includes: determining a first target transport block (transport block, TB), where the first target TB includes at least one modulation symbol, the at least one modulation symbol is obtained by modulating one bit group by using a first modulation scheme, the bit group includes at least one bit of each of at least two first code blocks (code block, CB), and the at least two first CBs are determined based on a to-be-transmitted TB; and sending the first target TB.

Based on this, the first communication device performs cascading modulation on the at least one bit of each of the at least two first CBs included in the one bit group, to obtain one modulation symbol. In other words, the one modulation symbol includes symbols obtained after a plurality of first CBs are mapped. In this way, when receiving the first target TB, a second communication device may determine, based on data that has been correctly demodulated, a plurality of locations at which a modulation symbol may appear and that are on a constellation diagram, thereby increasing a Euclidean distance of the constellation diagram, improving data demodulation performance, and improving a decoding success rate. In addition, a signal-to-noise ratio required for decoding is reduced.

With reference to the first aspect, in some implementations, bits included in the bit group are at least one bit of each first CB in one first CB group, and the one first CB group includes at least two different first CBs.

The first CB group includes the two different bits. In this way, when constellation diagram mapping is performed by using the first CB group, one constellation point may include bits corresponding to at least two different CBs. In this way, during demodulation, the second communication device may determine a plurality of locations at which a modulation symbol may appear in the constellation diagram. Therefore, the Euclidean distance of the constellation diagram is increased, data demodulation performance is improved, and a decoding success rate is improved.

With reference to the first aspect, in some implementations, the method further includes: grouping the at least two first CBs, to obtain at least one first CB group.

It should be understood that, when a quantity of first CBs is greater than 2, a grouping manner that may be used includes: sequential grouping, cyclic left (right) shift grouping, frequency domain interleaving grouping, or another grouping manner.

The frequency domain interleaving grouping manner has a strong capability of resisting frequency domain selective fading, and is applicable to a case in which a channel is poor or a channel changes greatly. Different grouping rules are used for different time of retransmission, so that a probability that all CBs in a CB group are incorrect can be reduced, thereby improving reliability of cascading transmission.

With reference to the first aspect, in some implementations, the at least two first CBs are obtained by encoding at least two second CBs, and the method further includes: segmenting the to-be-transmitted TB into the at least two second CBs when a length of the to-be-transmitted TB is greater than or equal to a segmentation threshold, where the segmentation threshold is less than a preset segmentation length of channel encoding.

With reference to the first aspect, in some implementations, the segmentation threshold is agreed on in a protocol or indicated by signaling.

A segmentation manner based on the segmentation threshold can better match a feature of cascading modulation of a plurality of code blocks.

With reference to the first aspect, in some implementations, the at least two first CBs are obtained by encoding at least two second CBs, and the method further includes: segmenting the to-be-transmitted TB into two second CBs when a length of the to-be-transmitted TB is less than a preset segmentation length of channel encoding; or segmenting the to-be-transmitted TB into 2n second CBs when a length of the to-be-transmitted TB is greater than or equal to a preset segmentation length of channel encoding, where n is an integer greater than 0.

In this way, the to-be-transmitted TB is segmented into an even quantity of second CBs, so that the to-be-transmitted TB can be better applicable to pair cascading transmission.

With reference to the first aspect, in some implementations, a quantity of second CBs is the same as a quantity of first CBs, one first CB corresponds to one second CB, different first CBs correspond to different second CBs, and each of the at least two first CBs includes a bit corresponding to a first redundancy version obtained by encoding a corresponding second CB.

With reference to the first aspect, in some implementations, the first redundancy version is determined based on a quantity of transmission times, an initial transmission bit rate, and a mapping relationship, and the mapping relationship indicates a correspondence between a redundancy version transmission sequence and a bit rate threshold.

Optionally, the mapping relationship may be determined based on a maximum encoding gain of retransmission. In this way, reliability of a retransmission link can be improved.

In the foregoing manner of determining the first redundancy version, a variable redundancy version may be used for transmission during each transmission. In this way, a channel encoding gain can be adaptively improved based on an actual link status, thereby improving link reliability.

With reference to the first aspect, in some implementations, the method further includes: determining a second target TB, where the second target TB includes a plurality of modulation symbols, and at least two of the plurality of modulation symbols are obtained by modulating different first CBs; and sending the second target TB.

With reference to the first aspect, in some implementations, the sending the second target TB includes: sending the second target TB on a time frequency resource, where modulation symbols corresponding to the different first CBs occupy different frequency domain resources and/or different time domain resources.

The modulation symbols corresponding to the different first CBs occupy the different frequency domain resources and/or the different time domain resources, so that channel environments are different. This can reduce a probability that both the two first CBs are incorrect, improve data demodulation performance, and improve link reliability.

With reference to the first aspect, in some implementations, the at least two different first CBs included in the first CB group meet at least one of the following: different bit rates, different transmission reliability requirements, different transmission bit error rate requirements, or different service types.

The first CB is transmitted in the foregoing manner, so that a probability that a plurality of CBs in one group are all incorrect can be reduced, thereby improving reliability of a retransmission cascading solution.

With reference to the first aspect, in some implementations, when there are a plurality of first CB groups, modulation schemes used by at least two of the plurality of first CB groups are different.

Different modulation schemes are used for different first CB groups, so that flexibility of a communication link can be enhanced.

With reference to the first aspect, in some implementations, the different first CBs meet at least one of the following: different bit rates, different modulation schemes used for transmission, different transmission reliability requirements, different transmission bit error rate requirements, or different service types.

In this manner, a probability that all CBs are incorrect during initial transmission can be reduced, and when cascading transmission is used for retransmission, a probability of some known information included in one modulation symbol during retransmission can be further increased, thereby increasing a gain of cascading modulation.

With reference to the first aspect, in some implementations, the method further includes: receiving or sending first information, where the first information indicates the first modulation scheme.

Optionally, the first modulation scheme may be cascading modulation.

According to a second aspect, a communication method is provided. The method may be performed by a second communication device, may be performed by a component (for example, a chip or a chip system) configured in the second communication device, or may be implemented by a logical module or software that can implement all or some functions of the second communication device. This is not limited in this application.

The method includes: receiving a first target TB, where the first target TB includes at least one modulation symbol, the at least one modulation symbol is obtained by modulating one bit group by using a first modulation scheme, the one bit group includes at least one bit of each of at least two first CBs, and the at least two first CBs are determined based on a to-be-transmitted TB; and demodulating the first target TB.

Based on this, when receiving the first target TB, the second communication device may determine, based on data that has been correctly demodulated during initial transmission, a plurality of locations at which a modulation symbol may appear in a constellation diagram. This improves data demodulation performance, improves a decoding success rate, and reduces a signal-to-noise ratio required for decoding.

With reference to the second aspect, in some implementations, bits included in the one bit group are at least one bit of each first CB in one first CB group, and the one first CB group includes at least two different first CBs.

With reference to the second aspect, in some implementations, the first CB group is obtained by grouping the at least two first CBs.

With reference to the second aspect, in some implementations, the at least two first CBs are obtained by encoding at least two second CBs, and the at least two second CBs are obtained by segmenting the to-be-transmitted TB.

With reference to the second aspect, in some implementations, a quantity of second CBs is determined based on a value relationship between a length of the to-be-transmitted TB and a segmentation threshold, and the segmentation threshold is agreed on in a protocol or indicated by signaling.

With reference to the second aspect, in some implementations, a quantity of second CBs is determined based on a value relationship between a length of the to-be-transmitted TB and a preset segmentation length of channel encoding.

With reference to the second aspect, in some implementations, a quantity of second CBs is the same as a quantity of first CBs, one first CB corresponds to one second CB, different first CBs correspond to different second CBs, and each of the at least two first CBs includes a bit corresponding to a first redundancy version obtained by encoding a corresponding second CB.

With reference to the second aspect, in some implementations, the first redundancy version is determined based on a quantity of transmission times, an initial transmission bit rate, and a mapping relationship, and the mapping relationship indicates a correspondence between a redundancy version transmission sequence and a bit rate threshold.

With reference to the second aspect, in some implementations, the at least two different first CBs included in the first CB group meet at least one of the following: different bit rates, different transmission reliability requirements, different transmission bit error rate requirements, or different service types.

With reference to the second aspect, in some implementations, when there are a plurality of first CB groups, modulation schemes used by at least two of the plurality of first CB groups are different.

With reference to the second aspect, in some implementations, the method further includes: receiving a second target TB, where the second target TB includes a plurality of modulation symbols, and at least two of the plurality of modulation symbols are obtained by modulating different first CBs; and demodulating the second target TB.

With reference to the second aspect, in some implementations, the receiving a second target TB includes: receiving the second target TB on a time frequency resource, where modulation symbols corresponding to the different first CBs occupy different frequency domain resources and/or different time domain resources.

With reference to the second aspect, in some implementations, the different first CBs meet at least one of the following: different bit rates, different modulation schemes used for transmission, different transmission reliability requirements, different transmission bit error rate requirements, or different service types.

With reference to the second aspect, in some implementations, the method further includes: receiving or sending first information, where the first information indicates the first modulation scheme.

For beneficial effect of the implementations of the second aspect, refer to the first aspect. Details are not described herein again.

According to a third aspect, a communication apparatus is provided, and is configured to perform the method according to any possible implementation of the first aspect. Specifically, the apparatus includes the module configured to perform the method according to any possible implementation of the first aspect.

In a design, the communication apparatus may include modules that are in one-to-one correspondence with the method/operation/step/action described in the first aspect. The modules may be implemented by a hardware circuit, software, or a combination of the hardware circuit and the software.

In another design, the communication apparatus is a communication chip, and the communication chip may include an input circuit or interface configured to send information or data, and an output circuit or interface configured to receive information or data.

In another design, the communication apparatus is a first communication device. The first communication device may include a transmitting machine configured to send information or data, and a receiving machine configured to receive information or data.

In another design, the communication apparatus is configured to perform the method in any possible implementation of the first aspect. The communication apparatus may be configured in a terminal or a network device, or the communication apparatus is the terminal or the network device.

According to a fourth aspect, another communication apparatus is provided, and is configured to perform the method according to any possible implementation of the second aspect. Specifically, the communication apparatus includes a module configured to perform the method according to any possible implementation of the second aspect.

In a design, the communication apparatus may include modules that are in one-to-one correspondence with the method/operation/step/action described in the second aspect. The modules may be implemented by a hardware circuit, software, or a combination of the hardware circuit and the software.

In another design, the communication apparatus is a communication chip, and the communication chip may include an input circuit or interface configured to send information or data, and an output circuit or interface configured to receive information or data.

In another design, the communication apparatus is a second communication device. The second communication device may include a transmitting machine configured to send information or data, and a receiving machine configured to receive information or data.

In another design, the communication apparatus is configured to perform the method in any possible implementation of the second aspect. The communication apparatus may be configured in a terminal or a network device, or the communication apparatus is a terminal or a network device.

According to a fifth aspect, another communication apparatus is provided. The communication apparatus includes a processor, configured to execute a computer program and/or use a logic circuit, to enable the communication apparatus to perform the method in any possible implementation of any one of the foregoing aspects.

Optionally, the communication apparatus further includes a memory, configured to store a computer program and/or a configuration file of the logic circuit.

It should be understood that there may be one or more processors, and there may be one or more memories.

Optionally, the communication device further includes a communication interface, configured to input and/or output a signal.

According to a sixth aspect, a communication system is provided, including a communication apparatus configured to implement the method according to any one of the first aspect or the possible implementations of the first aspect, or including a communication apparatus configured to implement the method according to any one of the second aspect or the possible implementations of the second aspect.

In a possible design, the communication system may further include a device that interacts with the first communication device and/or the second communication device in the solutions provided in embodiments of this application.

According to a seventh aspect, a computer program product is provided, where the computer program product includes a computer program (which may also be referred to as code or instructions), and when the computer program is run, a computer is enabled to perform the method according to any possible implementation of any one of the foregoing aspects.

According to an eighth aspect, a computer-readable storage medium is provided, where the computer-readable storage medium stores a computer program (which may also be referred to as code or instructions), and when the computer program is run on a computer, the computer is enabled to perform the method according to any possible implementation of any one of the foregoing aspects.

### BRIEF DESCRIPTION OF DRAWINGS

FIG. 1 is a diagram of a communication scenario applicable to a communication method according to an embodiment of this application;

FIG. 2 is a diagram of a signal processing process according to an embodiment of this application;

FIG. 3 is a diagram of a transport block transmission method according to this application;

FIG. 4 is a constellation diagram obtained through cascading modulation according to this application;

FIG. 5 is a schematic flowchart of a communication method according to an embodiment of this application;

FIG. 6 is a diagram of grouping first code blocks according to an embodiment of this application;

FIG. 7 is a diagram of a code block transmission method according to this application;

FIG. 8 is a diagram of another code block transmission method according to this application;

FIG. 9 is a block diagram of a communication apparatus according to an embodiment of this application; and

FIG. 10 is a block diagram of another communication apparatus according to an embodiment of this application.

### DESCRIPTION OF EMBODIMENTS

The following describes technical solutions of this application with reference to accompanying drawings.

The technical solutions provided in this application may be applied to various communication systems, for example, a long term evolution (long term evolution, LTE) system, an LTE frequency division duplex (frequency division duplex, FDD) system, an LTE time division duplex (time division duplex, TDD) system, a universal mobile communications system (universal mobile telecommunications system, UMTS), a 5G mobile communication system, a new radio (new radio, NR) system or another evolved communication system, and a next-generation mobile communication system of a 5G communication system such as a 6th generation (6th generation, 6G) communication system.

The technical solutions provided in this application may be further applied to machine type communication (machine type communication, MTC), long term evolution-machine (long term evolution-machine, LTE-M), a device-to-device (device-to-device, D2D) network, a machine-to-machine (machine-to-machine, M2M) network, an internet of things (internet of things, IoT) network, or another network. The IoT network may include, for example, an internet of vehicles. Communication manners in an internet of vehicles system are collectively referred to as vehicle to X (vehicle to X, V2X, X can stand for anything). For example, V2X may include vehicle to vehicle (vehicle to vehicle, V2V) communication, vehicle to infrastructure (vehicle to infrastructure, V2I) communication, vehicle to pedestrian communication (vehicle to pedestrian, V2P), vehicle to network (vehicle to network, V2N) communication, or the like.

The technical solutions provided in this application may be further applied to a non-terrestrial communication network (non-terrestrial network, NTN) communication system such as a satellite communication system. The NTN communication system may be integrated with a wireless communication system.

The technical solutions in embodiments of this application may be further applied to an inter-satellite communication system, a wireless projection system, a virtual reality (virtual reality, VR) communication system, an integrated access and backhaul (integrated and access backhaul, IAB) system, a wireless fidelity (wireless fidelity, Wi-Fi) communication system, an optical communication system, or the like.

The technical solutions provided in this application may be further applied to a D2D communication system, a V2X communication system, an M2M communication system, an MTC system, an IoT communication system, an integrated communication and sensing system, or another communication system.

An applied communication system and a network architecture of the communication system are not specifically limited in the technical solutions in embodiments of this application.

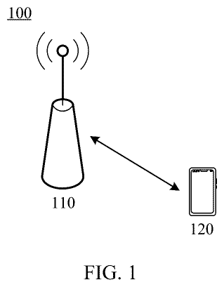

For ease of understanding of embodiments of this application, a communication system to which embodiments of this application are applicable is first described in detail with reference to FIG. 1.

FIG. 1 is a diagram of a communication scenario applicable to a communication method according to an embodiment of this application. As shown in FIG. 1, the communication system 100 includes at least two communication devices, for example, a network device 110 and at least one terminal 120. Data communication may be performed between the network device 110 and the at least one terminal 120 through a wireless connection. Specifically, the network device 110 may send downlink data to the terminal 120, and the terminal 120 may also send uplink data to the network device 110.

In embodiments of this application, a terminal (for example, the terminal 120 shown in FIG. 1) is a device having a wireless transceiver function, and may also be referred to as user equipment (user equipment, UE), a mobile station (mobile station, MS), a mobile terminal (mobile terminal, MT), an access terminal, a subscriber unit, a subscriber station, a mobile station, a remote station, a remote terminal, a mobile device, a user terminal, a terminal, a wireless communication device, a user agent, a user apparatus, or the like.

The terminal is a device that provides a user with voice and/or data connectivity, for example, a handheld device or a vehicle-mounted device having a wireless connection function. Currently, some examples of the terminal are a mobile phone (mobile phone), a tablet computer, a notebook computer, a palmtop computer, a mobile internet device (mobile internet device, MID), a wearable device, a VR device, an augmented reality (augmented reality, AR) device, a wireless terminal in industrial control (industrial control), a wireless terminal in self-driving (self-driving), a wireless terminal in remote surgery (remote medical surgery), a wireless terminal in a smart grid (smart grid), a wireless terminal in transportation safety (transportation safety), a wireless terminal in a smart city (smart city), a wireless terminal in a smart home (smart home), a sensor terminal, a sensing terminal, an integrated sensing and communication device, a cellular phone, a cordless phone, a session initiation protocol (session initiation protocol, SIP) phone, a wireless local loop (wireless local loop, WLL) station, a personal digital assistant (personal digital assistant, PDA), a handheld device having a wireless communication function, a computing device or another processing device connected to a wireless modem, a vehicle-mounted device, an unmanned aerial vehicle, a wearable device, a terminal in a 5G network, or a terminal in a future evolved public land mobile communication network (public land mobile network, PLMN). A specific technology, a device form, and a name used by the terminal are not limited in embodiments of this application.

As an example rather than a limitation, in this application, the terminal may be a terminal in an internet of things (internet of things, IoT) system. The internet of things is an important part in future development of information technologies. A main technical feature of the internet of things is to connect things to a network by using a communication technology, to implement an intelligent network for human-machine interconnection and thing-thing interconnection. For example, the terminal in embodiments of this application may be a wearable device. The wearable device may also be referred to as a wearable intelligent device, and is a general term of a wearable device that is intelligently designed and developed for daily wear by using a wearable technology, for example, glasses, gloves, a watch, clothing, and shoes. The wearable device is a portable device that can be directly worn on a body or integrated into clothes or an accessory of a user. Wearable devices are not only hardware devices, and can implement powerful functions through software support, data interaction, and cloud interaction. In a broad sense, wearable intelligent devices include full-featured and large-sized devices that can implement all or a part of functions without depending on smartphones, for example, smart watches or smart glasses, and include devices that focus on only one type of application function and need to collaboratively work with other devices such as smartphones, for example, various smart bands or smart jewelry for monitoring physical signs.

In this application, a network device may be a device (for example, the network device 110 shown in FIG. 1) configured to communicate with the terminal, or may be a device that enables the terminal to access a wireless network. The network device may be a node in a radio access network. The network device may be a base station (base station), an evolved NodeB (evolved NodeB, eNodeB), a transmission reception point (transmission reception point, TRP), a home base station (for example, a home evolved NodeB or a home NodeB, HNB), a Wi-Fi access point (access point, AP), a mobile switching center, a next generation base station (next generation NodeB, gNB) in a 5G mobile communication system, a next generation base station in a 6G mobile communication system, a base station in a future mobile communication system, or the like. Alternatively, the network device may be a module or a unit that implements some of functions of the base station, for example, may be a central unit (central unit, CU), a distributed unit (distributed unit, DU), a remote radio unit (remote radio unit, RRU), or a baseband unit (baseband unit, BBU). Alternatively, the network device may be a base station in a D2D communication system, a drone communication system, a V2X communication system, an M2M communication system, an IoT communication system, or the like. Alternatively, the network device may be a network device in an NTN, in other words, the network device may be deployed on a high altitude platform or a satellite. The network device may be a macro base station, or may be a micro base station or an indoor base station, or may be a relay node, a donor node, or the like. Certainly, the network device may alternatively be a node in a core network. A specific technology, a device form, and a name used by the network device are not limited in embodiments of this application.

In embodiments of this application, the function of the network device may alternatively be performed by a module (for example, a chip) in the network device, or may be performed by a control subsystem including the function of the network device. The control subsystem including the function of the network device herein may be a control center in the foregoing terminal application scenarios such as a smart grid, industrial control, intelligent transportation, a smart city, and an integrated sensing and communication system. A function of the terminal may be performed by a module (for example, a chip or a modem) in the terminal, or may be performed by an apparatus including the function of the terminal.

It should be noted that roles of the network device and the terminal may be relative. For example, a network device #1 may be configured as a mobile base station. For terminals that access a network through the network device #1, the network device #1 is a base station. However, for a network device #2 that communicates with the network device #1 through a wireless air interface protocol, the network device #1 is a terminal. Certainly, the network device #1 and the network device #2 may also communicate with each other through an interface protocol between base stations. In this case, the network device #1 is also a base station relative to the network device #2.

In embodiments of this application, both the network device and the terminal may be collectively referred to as a communication device or a communication apparatus. For example, the base station may be referred to as a communication device having a base station function, and the terminal may be referred to as a communication device having a terminal function. The network device and the terminal in this application may be deployed on land, including being deployed indoor, outdoor, handheld, wearable, or vehicle-mounted; or may be deployed on a water surface (for example, on a ship); or may be deployed in the air (for example, on an airplane, a balloon, or a satellite). Application scenarios of the network device and the terminal are not limited in this application.

In embodiments of this application, communication between the network device and the terminal, communication between network devices, and communication between terminals may be performed by using a licensed spectrum, or may be performed by using an unlicensed spectrum, or may be performed by using both a licensed spectrum and an unlicensed spectrum. The technical solutions of this application are applicable to a low frequency scenario, for example, sub 6G (which is a frequency band below 6 GHz, and may specifically be 6 gigahertz (gigahertz, GHz) (which may be referred to as 6G for short) with a working frequency from 440 megahertz (megahertz, MHz) to 6000 MHz), and are also applicable to a high frequency scenario (for example, above 6 GHz, for example, 28 GHz or 70 GHz), terahertz (terahertz, THz), optical communication, and the like. For example, the network device and the terminal may communicate with each other by using a spectrum below 6 GHz, may communicate with each other by using a spectrum above 6 GHz, or may communicate with each other by using both a spectrum below 6 GHz and a spectrum above 6 GHz. A spectrum resource used for communication is not limited in embodiments of this application.

The technical solutions provided in this application may be further applied to various types of communication links, for example, a user to network universal (user to network interface universal, Uu) link, a satellite link, a sidelink (sidelink, SL), and a relay link. This is not limited in this application.

It should be understood that FIG. 1 is merely a simplified diagram for ease of understanding. The communication system 100 may further include another device, which is not shown in FIG. 1.

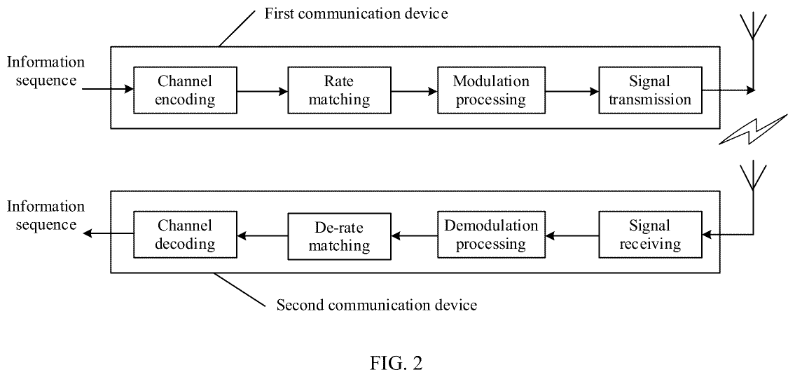

Refer to FIG. 2. The following briefly describes a process of processing to-be-transmitted data at a physical layer when the network device 110 performs data communication with the at least one terminal 120. It should be understood that the signal processing process shown in FIG. 2 may be performed by the network device, or may be performed by the terminal device. This is not limited in this application.

As shown in FIG. 2, when sending information data, a first communication device (for example, may be the network device 110 or the terminal 120 shown in FIG. 1) may segment, based on a transport block size supported by a system, the information data from an upper layer (for example, a media access control (media access control, MAC) layer) into a plurality of transport blocks (transport block, TB), and add cyclic redundancy check (cyclic redundancy check, CRC) check bits p₀, p₁, p₂, p₃, . . . , p_{L-1} of a same length to each transport block a₀, a₁, a₂, a₃, . . . , a_{A-1} to obtain a sequence b₀, b₁, b₂, b₃, . . . , b_{B-1} (that is, A+L=B, where when A is the bit length of the transport block a₀, L is a length of P₀, and B is a bit length of a sequence b₀). The obtained sequence b₀, b₁, b₂, b₃, . . . , b_{B-1} may be referred to as a to-be-transmitted TB in this application.

It should be understood that the foregoing process of adding CRC check of a same length to each transport block a₀, a₁, a₂, a₃, . . . , a_{A-1} may be an optional step. When a process of adding CRC check to each transport block is not included, the transport block a₀, a₁, a₂, a₃, . . . , a_{A-1} obtained through segmentation may be referred to as a to-be-transmitted TB in this application.

If a size of the transport block b₀, b₁, b₂, b₃, . . . , b_{B-1} to which check is added exceeds a preset segmentation length of channel encoding, the transport block needs to be segmented into several code blocks (code block, CB), which may be referred to as second code blocks in this application. Each code block may include several bits in a transport block, and may further include CRC check bits of these bits. Then, the first communication device may perform channel encoding on each code block, for example, perform LDPC encoding, to obtain a corresponding encoded code block. Each encoded code block may include a plurality of information bits before encoding and check bits generated through encoding in the code block.

The first communication device may store the encoded bit sequence in a circular buffer of the first communication device for rate matching. The first communication device may select a segment of encoded bits from the circular buffer, perform modulation processing, map the segment of encoded bits to a modulation symbol, and send a signal including the modulation symbol.

The second communication device demodulates the received modulation symbol, and may store a soft value of the received encoded bit at a corresponding location in the soft information buffer. If retransmission occurs, the second communication device combines soft values of encoded bits in each time of retransmission and stores the soft values in the soft information buffer. The combination herein means that if locations of encoded bits received twice are the same, soft values of the encoded bits received twice are combined.

The second communication device may directly decode all soft values in the soft information buffer, for example, decode low density parity check code (low density parity check code, LDPC) to obtain a corresponding information sequence, for example, perform LDPC decoding to obtain a corresponding information sequence. An information sequence obtained through channel decoding may be sent to an upper layer (for example, a MAC layer).

It should be understood that a process in which the second communication device processes the received modulation symbol to obtain the information sequence may be considered as an inverse process of a process in which the first communication device processes the to-be-sent information data to obtain the encoded bit sequence.

Currently, to improve reliability of data transmission in a communication system, a blind retransmission solution is proposed. To be specific, a transmit end directly retransmits a data packet without waiting for ACK/NACK feedback information from the receive end. Although this retransmission manner can resolve a transmission delay problem, a gain brought by repeated transmission of same data is limited.

In view of this, embodiments of this application provide a communication method and a related apparatus. Cascading modulation is performed on at least one bit of each of at least two first CBs included in a bit group, to obtain one modulation symbol (that is, one modulation symbol includes bit information of a plurality of first CBs), and the modulation symbol is sent to the second communication device. In this way, when receiving a first target TB including at least one modulation symbol, the second communication device may determine, based on data that has been correctly demodulated, a plurality of locations at which a modulation symbol may appear and that are on a constellation diagram, thereby increasing a Euclidean distance of the constellation diagram, improving data demodulation performance, improving a decoding success rate, reducing a signal-to-noise ratio required for decoding, and improving link reliability.

It should be noted that service types to which the communication method provided in this embodiment of this application is applicable include a URLLC service, an enhanced mobile broadband (enhanced mobile broadband, eMBB) service, a voice over new radio (voice over new radio, VoNR) service, a massive machine type communication (massive machine type communications, mMTC) service, and the like.

Before the method provided in this application is described, the following several points are first described.

First, in this application, “indication” may include a direct indication and an indirect indication, or may include an explicit indication and an implicit indication. Information indicated by specific information is referred to as to-be-indicated information. In a specific implementation process, the to-be-indicated information may be indicated in many manners. For example, without limitation, the to-be-indicated information may be directly indicated, for example, the to-be-indicated information or an index of the to-be-indicated information is indicated. Alternatively, the to-be-indicated information may be indirectly indicated by indicating other information, and there is an association relationship between the other information and the to-be-indicated information. Alternatively, only a part of the to-be-indicated information may be indicated, and the other part of the to-be-indicated information is known or pre-agreed on. For example, specific information may alternatively be indicated by using an arrangement sequence of a plurality of pieces of information that is pre-agreed on (for example, stipulated in a protocol), to reduce indication overheads to some extent.

Second, in embodiments shown in this specification, terms and English abbreviations such as a to-be-transmitted TB, segmentation, and a segmentation threshold are all examples provided for ease of description, and should not constitute any limitation on this application. This application does not exclude a possibility of defining another term that can implement a same or similar function in an existing or future protocol.

Third, the first, the second, and various numerical numbers in the embodiments shown below are merely distinguished for ease of description, and are not intended to limit the scope of embodiments of this application. For example, different information and different moments are distinguished.

Fourth, in the following embodiments, “predefined” may be implemented by pre-storing corresponding code or a corresponding table in a device (for example, including a terminal device and a network device), or may be implemented in another manner that may indicate related information. A specific implementation of “predefined” is not limited in this application.

Fifth, the “protocol” in embodiments of this application may refer to standard protocols in the communication field, for example, may include an LTE protocol, an NR protocol, and a related protocol applied to a future communication system. This is not limited in this application.

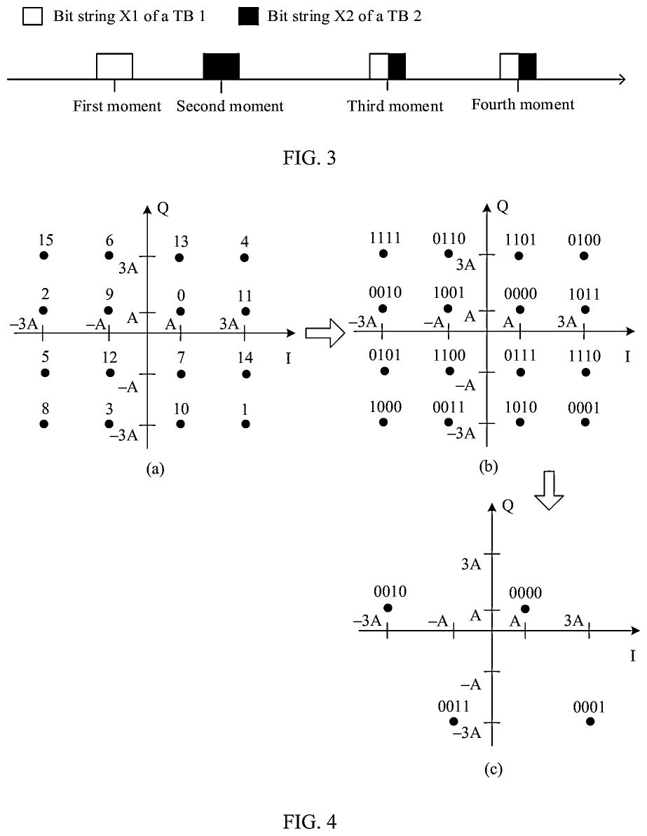

For example, when the network device 110 and the terminal 120 in FIG. 1 perform data transmission, a data packet may be transmitted in a manner shown in FIG. 3.

FIG. 3 is a diagram of a TB transmission method according to this application. As shown in FIG. 3, at a first moment, a first communication device maps a bit string X1 of a TB 1 to a 16-quadrature amplitude modulation (quadrature amplitude modulation, QAM) constellation diagram, to obtain a plurality of modulation symbols, and sends the plurality of modulation symbols to a second communication device.

In embodiments of this application, the first communication device may be a terminal or a network device, and the second communication device may also be a terminal or a network device.

At a second moment, the first communication device maps a bit string X2 of a TB 2 to a 16-QAM constellation diagram, to obtain a plurality of modulation symbols, and sends the plurality of modulation symbols to the second communication device.

The bit strings X1 and X2 are bit strings formed by performing CRC check, channel encoding, rate matching, and code block cascading, and lengths of the bit strings X1 and X2 may be equal or unequal.

At a third moment, the first communication device separately selects some bits from the bit strings X1 and X2 according to a first rule, then maps the some bits of X1 and X2 to the 16-QAM cascading constellation diagram in a cascading manner according to a second rule, to obtain a modulation symbol, and sends the modulation symbol to the second communication device.

It should be understood that the first rule and the second rule may be agreed on in a protocol, indicated by using signaling, or a combination of the foregoing two manners.

It should be further understood that the signaling in this application may be higher layer signaling, for example, radio resource control (radio resource control, RRC) signaling, or physical layer signaling, for example, downlink control information (downlink control information, DCI), uplink control information (uplink control information, UCI), or sidelink control information (sidelink control information, SCI).

For example, it is assumed that both the bit strings X1 and X2 are 2n (n is an integer greater than 0) bits. The first rule may be: the first n bits of the bit strings X1 and X2, a (2i+1)^{th} (a value of i ranges from 0 to n−1, and i is a positive integer) bit of X1 and X2, a 2j^{th} (a value of j ranges from 1 to n, and j is a positive integer) bit of each of X1 and X2, or the like. The second rule may be: mapping 2 bits of X1 to the first 2 bits of a constellation point, and mapping 2 bits of X2 to the last 2 bits of the constellation point; mapping 2 bits of X1 to a first bit and a third bit of the constellation point, and mapping 2 bits of X2 to a second bit and a fourth bit of the constellation point; or mapping 2 bits of X1 to a first bit and a fourth bit of the constellation point, and mapping 2 bits of X2 to a second bit and a third bit of the constellation point. Alternatively, 3 bits of X1 are mapped to the first 3 bits of a constellation point, and one bit of X2 is mapped to a fourth bit of the cascading constellation point. Alternatively, one bit of X1 is mapped to a first bit of the constellation point, and 3 bits of X2 is mapped to the last 3 bits of the cascading constellation point.

It should be understood that X1 and X2 in the second rule may be interchanged. For example, 2 bits of X2 are mapped to the first 2 bits of the constellation point, and 2 bits of X1 are mapped to the last 2 bits of the constellation point. However, it should be noted that the second rule is described by using the 16-QAM constellation diagram as an example. A modulation scheme of another order is, for example, an M-QAM modulation scheme (M=2N, and a value of N is an integer greater than 1). For example, a constellation point in the M-QAM constellation diagram can represent N-bit information, and N=log₂(M). If cascading modulation is performed by using the M-QAM constellation diagram, in N bits of the constellation point in the M-QAM constellation diagram, N/2 bits may be from a data packet X1, and the other N/2 bits are from a data packet X2.

At a fourth moment, the first communication device extracts remaining bits from the bit strings X1 and X2, maps the remaining bits in X1 and X2 to 16-QAM constellation point with cascading mapping according to the same second rule, and sends the remaining bits to the second communication device.

It should be noted that the first moment, the second moment, the third moment, and the fourth moment are four different moments, the fourth moment is after the third moment, the third moment is after the second moment, and the second moment is after the first moment.

It should be understood that this mapping manner used for the foregoing retransmission may be referred to as cascading mapping, cascading modulation, or another name. In other words, bit information of two different data packets is mixed and mapped to a point on a same constellation diagram. A transmission manner in which cascading modulation is used may be referred to as cascading transmission or another name. This is not limited in this application.

It should be further understood that one cascading constellation diagram may further include bits in more TB packets. An implementation of the bits in the more TB packets is similar to that of two TB packets. For brevity, details are not described in this application.

The following uses a 16-QAM constellation diagram as an example to describe in detail the foregoing constellation diagram obtained through cascading modulation with reference to FIG. 4. A horizontal coordinate of the constellation diagram shown in FIG. 4 represents an in-phase (in-phase) component I, and a vertical axis represents a quadrature (quadrature) component Q.

As shown in FIG. 4, each quadrant in the 16-QAM constellation diagram includes four constellation points, horizontal coordinates corresponding to the constellation points are [−3A, −A, A, 3A], and vertical coordinates corresponding to the constellation points are [−3A, −A, A, 3A]. A is a normalization factor, for example, A=1/\sqrt{10}. A decimal value of each constellation point is shown in (a) in FIG. 4. A binary representation (4 bits) of each constellation point may be obtained by converting decimal shown in (a) in FIG. 4 into binary, to obtain (b) in FIG. 4.

In the cascading modulation scheme shown in FIG. 3, the first 2 bits of 4 bits at one constellation point in the 16-QAM constellation diagram correspond to a symbol obtained by mapping X1, and the last 2 bits correspond to a symbol obtained by mapping X2. During initial transmission, if X1 is correctly demodulated, and X2 is not correctly demodulated, for example, the first 2 bits of a known constellation point are 00, after a receive end receives a modulation symbol retransmitted in the cascading modulation scheme shown in FIG. 3, the receive end may determine that corresponding constellation points are the four constellation points shown in (c) in FIG. 4 (a Euclidean distance of the four constellation points is twice that of 16-QAM). In this case, demodulation may be performed on the four constellation points shown in (c) in FIG. 4. A probability of successfully decoding a modulation symbol changes from 1/16 to ¼, so that data demodulation performance is improved, a decoding success rate at the receive end is improved, and a signal-to-noise ratio required for decoding is reduced.

In conclusion, when the receive end knows X1 or X2, a retransmission manner in which a cascading modulation scheme is used increases the Euclidean distance of the constellation diagram, thereby improving data demodulation performance. However, in a TB packet-based cascading transmission solution, two to-be-transmitted TBs need to be respectively sent to the receive end at the first moment and the second moment, and a transmit end can start data packet retransmission at the third moment and the fourth moment only after transmission of the two TBs ends. Because the constellation diagram at the third moment (or the fourth moment) includes only some bits in the TB 1 at the first moment and some bits in the TB 2 at the second moment, when the TB 1 at the first moment (or the TB 2) is not correctly demodulated, the TB 1 (or the TB 2) can be decoded only when retransmitted data at the fourth moment arrives. It can be learned that, in this TB packet-based cascading transmission solution, a transmission delay is large, and a transmission delay requirement in a URLLC scenario cannot be met.

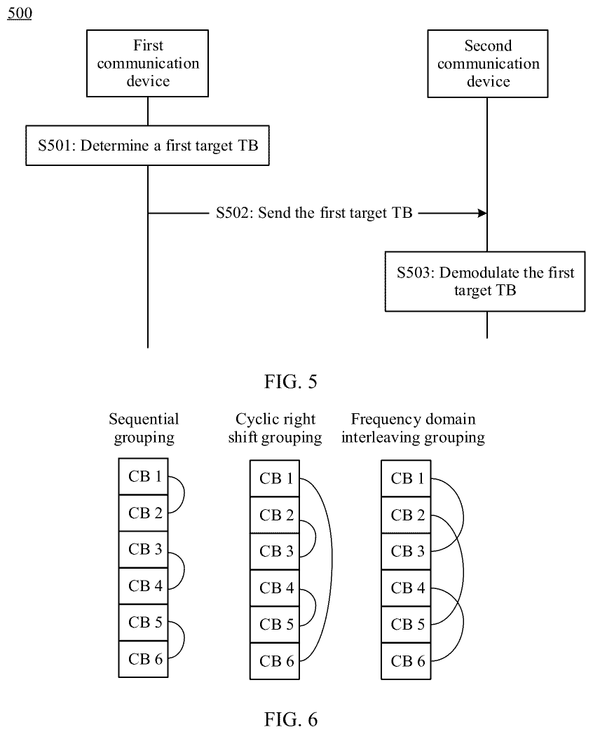

Based on this, this application provides a CB-based cascading transmission solution. The following describes in detail the CB-based cascading transmission solution with reference to FIG. 5.

FIG. 5 is a schematic flowchart of a communication method 500 according to an embodiment of this application; It should be understood that the method 500 may be applied to the communication system 100 shown in FIG. 1. However, this embodiment of this application is not limited thereto. In FIG. 5, an example in which a first communication device and a second communication device are execution bodies of interaction is used to illustrate the method 500. However, the execution bodies of the interaction are not limited in this application. For example, the first communication device in FIG. 5 may alternatively be a chip, a chip system, or a processor that supports the communication device in implementing the method, or may be a logical module or software that can implement all or some functions of the first communication device. The second communication device in FIG. 5 may alternatively be a chip, a chip system, or a processor that supports the communication device in implementing the method, or may be a logical module or software that can implement all or some functions of the second communication device.

It should be understood that the first communication device in FIG. 5 may be a terminal or a network device, and the second communication device may also be a terminal or a network device. For example, interaction shown in FIG. 5 may be interaction between a terminal (the first communication device) and a network device (the second communication device), interaction between a terminal (the first communication device) and a terminal (the second communication device), or interaction between a network device (the first communication device) and a network device (the second communication device).

As shown in FIG. 5, the method 500 may include S501 to S503. The following describes the steps in the method 500 in detail.

S501: The first communication device determines a first target TB.

The first target TB includes at least one modulation symbol, the at least one modulation symbol is obtained by modulating one bit group by using a first modulation scheme, the one bit group includes at least one bit of each of at least two first CBs, and the at least two first CBs are determined based on a to-be-transmitted TB.

S502: The first communication device sends the first target TB. Correspondingly, the second communication device receives the first target TB.

S503: The second communication device demodulates the first target TB.

It should be understood that demodulation of a modulation symbol may be implemented with reference to the conventional technology, and details are not described herein.

In this embodiment of this application, the first communication device performs cascading mapping on the at least one bit of each of the at least two first CBs included in the one bit group, to obtain one modulation symbol. In other words, the one modulation symbol includes symbols obtained by mapping a plurality of first CBs. In this way, when receiving the first target TB, the second communication device may determine, based on data that has been correctly demodulated, a plurality of locations at which a modulation symbol may appear and that are on a constellation diagram, thereby increasing a Euclidean distance of the constellation diagram, improving data demodulation performance, and improving a decoding success rate. In addition, a signal-to-noise ratio required for decoding is reduced.

Lengths of the at least two first CBs are the same. If the lengths are different, 0 or 1 may be added, to cause a same length of the two CBs.

Optionally, the first communication device may send or receive first information that indicates the first modulation scheme. The first modulation scheme may be cascading modulation. To be specific, bit information mapped to one constellation point includes bit information of at least two different code blocks.

It should be understood that the first target TB is a modulation symbol obtained when the to-be-transmitted TB is retransmitted. The to-be-transmitted TB may be a transport block obtained by segmenting data from a MAC layer, or may be a sequence obtained by adding CRC check to a transport block obtained by segmenting data from a MAC layer.

In a possible implementation, the bit group includes at least one bit of each first CB in one first CB group, and the one first CB group includes at least two different first CBs.

It should be understood that a quantity of first CBs included in the one first CB group may be determined based on a quantity of times of cascading modulation. For example, if pair cascading is performed, the one first CB group includes two first CBs; if triple cascading is performed, the one first CB group includes three first CBs.

In a possible implementation, the method 500 further includes: grouping the at least two first CBs, to obtain at least one first CB group.

Optionally, the foregoing grouping manner may be another manner such as sequential grouping, cyclic left (right) shift grouping, or frequency domain interleaving grouping. It should be understood that, when retransmission occurs for a plurality of times, a different grouping manner may be used for each time of retransmission.

For example, there are 2n first CBs, and sequence numbers of the 2n first CBs are respectively 1, 2, 3, . . . , and 2n. If pair grouping is performed in the sequential grouping manner, the following may be obtained: (1, 2) (3, 4) (5, 6) . . . (2n−1, 2n); or (1, 3) (2, 4) (5, 7) . . . (2n−1, 2n); or (1, n+1) (2, n+2) (3, n+3) . . . (n, 2n), or another similar combination. If pair grouping is performed in the cyclic right (left) shift manner, the following may be obtained: (2, 3) (4, 5) (6, 7) . . . (2n, 1). If pair grouping is performed in the frequency domain (or random) interleaving manner, the following may be obtained: (1, 4) (5, 6) (8, 2) . . . (2, 2n−7), or (7, 12) (2, 1) (6, 5) . . . (2n−1, 1). Alternatively, an irregular frequency domain (or random) interleaving grouping manner is used. The foregoing sequential grouping manner and the cyclic right (left) shift grouping manner facilitate storage of a grouping manner, and the frequency domain (or random) interleaving grouping manner has a strong capability of resisting frequency domain selective fading, and is applicable to a case in which a channel is poor or a channel changes greatly.

When n=3, a “pair” grouping manner is used as an example to describe in detail three grouping manners with reference to FIG. 6. In the three grouping manners shown in FIG. 6, a sequence number in a bracket of each grouping manner indicates two CBs that participate in one cascading constellation diagram. According to sequential grouping, the following is obtained: a CB 1 and a CB 2, a CB 3 and a CB 4, and a CB 5 and a CB 6. According to cyclic right shift grouping, the following is obtained: a CB 1 and a CB 6, a CB 2 and a CB 3, and a CB 4 and a CB 5. According to the frequency domain interleaving grouping manner, the following is obtained: a CB 1 and a CB 3, a CB 2 and a CB 5, and a CB 4 and a CB 6.

In a possible implementation, the at least two first CBs are obtained by encoding at least two second CBs, and the at least two second CBs are obtained by segmenting the to-be-transmitted TB. Encoding may be a series of processing such as channel encoding, interleaving processing (optional), and rate matching.

With reference to the example in FIG. 2, the following describes in detail how to determine the 2n first CBs based on the to-be-transmitted TB.

After obtaining the to-be-transmitted TB in the manner shown in FIG. 2, the first communication device needs to segment the to-be-transmitted TB. The following provides two possible designs for segmenting the TB as examples.

Design 1: When a length B of the to-be-transmitted TB is less than a preset segmentation length K_{cb} of channel encoding, the to-be-transmitted TB is segmented into two second CBs; or when the length of the to-be-transmitted TB is greater than or equal to the preset segmentation length of channel encoding, the to-be-transmitted TB is segmented into 2n second CBs, where n is an integer greater than 0.

For example, when B is less than or equal to K_{cb}, the to-be-transmitted TB is segmented into two code blocks, and a CRC check bit whose length L2 is 24 is added to each code block obtained through segmentation, to obtain two second CBs. However, for a to-be-transmitted TB whose length is less than K_{cb}, a length of an information bit of the to-be-transmitted TB is limited. Therefore, CRC with a smaller length L2 (for example, L2=0, 6, 11, or 16) may be selected, or no CRC is added. In this way, CRC overheads in a small packet (the to-be-transmitted TB whose length is less than K_{cb}) can be reduced, and transmission efficiency of the small packet can be improved.

Design 2: When the length B of the to-be-transmitted TB is greater than or equal to a segmentation threshold kₘᵢₙ, the to-be-transmitted TB is segmented into at least two second CBs.

Optionally, the segmentation threshold is agreed on in a protocol or indicated by signaling, and the signaling may be higher layer signaling (for example, RRC) or physical layer signaling (for example, DCI).

Optionally, the segmentation threshold kₘᵢₙ is less than the preset segmentation length K_{cb} of channel encoding, or the segmentation threshold kₘᵢₙ is greater than the preset segmentation length K_{cb} of channel encoding. It should be understood that the segmentation threshold may be determined based on a gain brought by the cascading transmission manner and an encoding loss caused by TB segmentation. For example, when the length of the to-be-transmitted TB is greater than or equal to the segmentation threshold, the gain brought by the cascading transmission manner is greater than the encoding loss caused by TB segmentation. When the length of the to-be-transmitted TB is less than the segmentation threshold, the gain brought by the cascading transmission manner is less than the encoding loss caused by TB segmentation.

For example, when the segmentation threshold kₘᵢₙ is less than the preset segmentation length K_{cb} of channel encoding, and B is less than or equal to kₘᵢₙ, segmentation is not performed. B is the length of the to-be-transmitted TB. When B is greater than kₘᵢₙ and less than K_{cb}, the to-be-transmitted TB is segmented into two code blocks, and a CRC check bit whose length is L2 is added to each code block to obtain two second CBs. However, for the to-be-transmitted TB whose length is less than K_{cb}, the length of the information bit of the to-be-transmitted TB is limited. Therefore, CRC with a smaller length (L2) may be selected (for example, L2=0, 6, 11, or 16, where L2=0 indicates that no CRC check bit is added to a code block). In this way, CRC overheads in a small packet (the to-be-transmitted TB whose length is less than K_{cb}) can be reduced, and transmission efficiency of the small packet can be improved.

It should be understood that, if the to-be-transmitted TB is not segmented, the CRC check bit may not need to be added after the to-be-transmitted TB.

In the foregoing two examples, when B is greater than K_{cb}, a formula C=ceil (B/(K_{cb}−L2)) (ceil in the formula is a rounding function, and ceil (x) indicates that a minimum integer greater than x is returned, that is, C is a minimum integer greater than B/(K_{cb}−L2). For example, if B/(K_{cb}−L2)=8.3, C=9), a quantity C of code blocks that can be obtained through segmentation is determined. If 2n−1 code blocks can be obtained through segmentation, that is, C=2n−1, when the to-be-transmitted TB is segmented, the to-be-transmitted TB is segmented into 2n code blocks, that is, C=2n=2n−1+1. A same CRC check bit is added to each code block to obtain 2n second CBs. To implement pair cascading mapping, the 2n−1 code blocks need to be segmented into 2n code blocks. Therefore, in this segmentation manner, a CRC check bit with a small length (for example, a length L2 of CRC=0, 6, 11, or 16) may be selected. This reduces CRC overheads in segmentation, and reduces CRC overheads added after the segmentation into more code blocks.

For example, when the segmentation threshold kₘᵢₙ is greater than the preset segmentation length K_{cb} of channel encoding, and B is greater than kₘᵢₙ, the to-be-transmitted TB is segmented into 2n code blocks, and a same CRC check bit is added to each code block to obtain 2n second CBs. B is the length of the to-be-transmitted TB. When B is greater than K_{cb} and is less than kₘᵢₙ, the to-be-transmitted TB is segmented into two code blocks, and a CRC check bit whose length is L2 is added to each code block to obtain two second CBs. When B is greater than k_{cb}, the to-be-transmitted TB is not segmented.

It should be understood that, when pair cascading is not required, for example, when triple cascading is used, the to-be-transmitted TB may alternatively be segmented into M second CBs (Mis an integer multiple of 3).

It should be understood that the segmentation threshold and the preset channel encoding length may coexist. In this way, when two communication parties segment the to-be-transmitted TB by using the segmentation threshold, whether to use a segmentation threshold solution may be determined by using a signaling indication or in a manner agreed in a protocol. For example, 1 bit in physical layer signaling or higher layer signaling is used to indicate whether to use the segmentation threshold. 1 indicates that a solution with the segmentation threshold is used, and 0 indicates that a solution without the segmentation threshold is used. Alternatively, 0 indicates that a solution with the segmentation threshold is used, and 1 indicates that a solution without the segmentation threshold is used. The signaling in this application may be higher layer signaling, for example, no RRC signaling, or physical layer signaling, for example, DCI.

In a possible implementation, a quantity of second CBs is the same as a quantity of first CBs, one first CB corresponds to one second CB, different first CBs correspond to different second CBs, and each of the at least two first CBs includes a bit corresponding to a first redundancy version obtained by encoding a corresponding second CB.

It can be learned with reference to the example in FIG. 2 and the foregoing segmentation example that, when the plurality of second CBs are obtained, channel encoding and rate matching may be performed on the plurality of second CBs, to obtain a plurality of redundancy versions. In other words, each second CB corresponds to the plurality of redundancy versions. A first redundancy version may be any one of the plurality of redundancy versions.

For example, after LDPC encoding is used to obtain a corresponding encoded code block, the first communication device may store a bit sequence of the obtained encoded code block in a circular buffer of the first communication device for rate matching. In a rate matching module, the first communication device may distinguish, by using a ring buffer, encoded bits corresponding to an encoded code block into four redundancy versions (redundancy version, RV) (RV 0 to RV 3). The RV 0 is used for sending during initial transmission. If retransmission is required, the RV 0 is sent based on a redundancy version transmission sequence agreed on in a protocol. For example, the redundancy version transmission sequence agreed on in the protocol may be {0231}, {0303}, {0000}, or the like. Because the redundancy versions have different start locations, the redundancy versions correspond to different encoded bit sets.

In a possible implementation, the first redundancy version is determined based on a quantity of transmission times, an initial transmission bit rate, and a mapping relationship. The mapping relationship indicates a correspondence between a redundancy version transmission sequence and a bit rate threshold.

Optionally, the mapping relationship may be agreed on in a protocol, or may be indicated by signaling. The signaling may be higher layer signaling (for example, RRC signaling), or may be physical layer signaling (for example, DCI).

In some possible implementations, the mapping relationship may be designed based on a criterion of maximizing a channel encoding gain. A criterion for maximizing the channel encoding gain is that a complete channel encoding codeword is preferentially transmitted. If a plurality of parity bits (parity bit) are not transmitted, the parity bits are transmitted first. If most of information bits (for example, information bits in a transmitted channel encoded codeword exceed half of information bits included in an encoded code block) and most of the parity bits (for example, after parity bits in the transmitted channel encoded codeword exceed half of the parity bits included in the encoded code block) are completely transmitted for n times, the information bits (information bit) are preferentially transmitted. When a quantity of check bits included in a channel encoded codeword that is preferentially transmitted is less than half of a quantity of check bits included in an encoded code block, it is considered that a plurality of check bits are not transmitted. The encoded code block is a code block before rate matching, that is, the second CB.

The following uses a base graph (base graph, BG) 1 of an LDPC as an example to briefly describe a criterion for maximizing the channel encoding gain. A 0^{th} column to a 21^{st} column of the BG 1 correspond to encoded bits of information bit information, and a 22^{nd} column to a 67^{th} column correspond to encoded bits of check information. Columns 0 and 1 are punctured information bit information, encoded bits corresponding to the punctured information bit information do not enter a circular buffer, and only encoded bits corresponding to information in a 2^{nd} column to the 67^{th} column enter the circular buffer.

Start locations of buffers corresponding to the RV 0 to the RV 3 are respectively {0Zc, 17Zc, 33Zc, 56Zc}, where Zc represents a lifting size (lifting size). When the redundancy versions RV 0 and RV 3 are selected, bits output by the rate matching module include a large amount of information bit information. When the redundancy versions RV 1 and RV 2 are selected, bits output by the rate matching module include a large amount of parity bit information.

When an initial transmission bit rate is large, for example, greater than or equal to 4/9, a redundancy version transmission sequence is {RV 0, RV 2, RV 3, RV 1}. When the redundancy version RV 0 selected for a first time of transmission includes more information bit information, check information corresponding to the RV 0 is less than check information corresponding to the BG 1. In this case, remaining parity bit information is transmitted as much as possible in a time of second transmission, and the RV 2 may be selected for the time of second transmission. A criterion for a third time of transmission is to supplement the check bit information, and preferentially transmit the information bit information. Therefore, the redundancy version RV 3 is selected for the third time of transmission. A criterion for a fourth time of transmission is to supplement the information bit information, and remaining parity bit information is preferentially transmitted. Therefore, the redundancy version RV 1 is selected for the fourth time of transmission.

When the initial transmission bit rate is small (less than 4/9), the redundancy version transmission sequence is {RV 0, RV 3, RV 2, RV 1}. For a transmission rule of the redundancy version, refer to the foregoing transmission rule when the initial transmission bit rate is large. Details are not described herein again.

The initial transmission bit rate=the information bits of the encoded code block/the bits output by the initial transmission rate matching module.

Optionally, the redundancy version transmission sequence may be further related to a service type, a transmission mode, and the like.

Optionally, the first redundancy version may alternatively be determined based on a redundancy version transmission sequence agreed on in an existing protocol.

In this embodiment of this application, a variable redundancy version may be used for transmission during each transmission. In this way, a channel encoding gain can be adaptively improved based on an actual link status, thereby improving link reliability. In a possible implementation, the at least two different first CBs included in the first CB group meet at least one of the following: different bit rates, different transmission reliability requirements, different transmission bit error rate requirements, or different service types.

For example, one of two first CBs in one first CB group is allocated with a high bit rate (2/3), and the other first CB is allocated with a low bit rate (1/3); or two first CBs in one first CB group are respectively a CB of a URLLC service and a CB of an eMBB service. In this way, a probability that both the two first CBs are incorrect is reduced, thereby improving reliability of a cascading transmission link.

In a possible implementation, when there are a plurality of first CB groups, modulation schemes used by at least two of the plurality of first CB groups are different.

For example, in the two first CB groups, one first CB group uses 16-QAM, and the other first CB group uses 4-QAM.

In a possible implementation, the method 500 further includes: The first communication device determines a second target TB, where the second target TB includes a plurality of modulation symbols, and at least two of the plurality of modulation symbols are obtained by modulating different first CBs; and the first communication device sends the second target TB. Correspondingly, the second communication device receives the second target TB, and demodulates the second target TB.

It should be understood that bit information corresponding to any one of the plurality of modulation symbols belongs to a same first CB.

It should be further understood that the second target TB is a modulation symbol obtained when the to-be-transmitted TB is initially transmitted. The first CB corresponding to the first target TB and the first CB corresponding to the second target TB may be a same bit, or may be bits included in different redundancy versions corresponding to a same second CB. For example, if a plurality of redundancy versions corresponding to the second CB are an RV 0, an RV 1, an RV 2, and an RV 3, the first CB corresponding to the first target TB may be a bit included in the RV 1 of the second CB, and the first CB corresponding to the second target TB may be a bit included in the RV 0 of the second CB.

In a possible implementation, the sending the second target TB includes: sending the second target TB on a time frequency resource, where modulation symbols corresponding to different first CBs occupy different frequency domain resources and/or different time domain resources. Correspondingly, the receiving a second target TB includes: receiving the second target TB on a time frequency resource, where modulation symbols corresponding to the different first CBs occupy different frequency domain resources and/or different time domain resources.

The modulation symbols corresponding to the different first CBs occupy the different frequency domain resources and/or the different time domain resources, so that channel environments are different. This can reduce a probability that both the two first CBs are incorrect, improve data demodulation performance, and improve link reliability.

In a possible implementation, the different first CBs meet at least one of the following: different bit rates, different modulation schemes used for transmission, different transmission reliability requirements, different transmission bit error rate requirements, or different service types.

The foregoing different bit rates, different modulation schemes used for transmission, different transmission reliability requirements, different transmission bit error rate requirements, or different service types may all be referred to as asymmetric encoding. In this manner, a probability that all CBs are incorrect during initial transmission can be reduced, and when cascading transmission is used for retransmission, a probability of some known information included in one modulation symbol during retransmission can be further increased, thereby increasing a gain of cascading modulation.

It should be understood that a specific asymmetric encoding manner used by the communication device may be agreed on in a protocol or indicated by signaling.

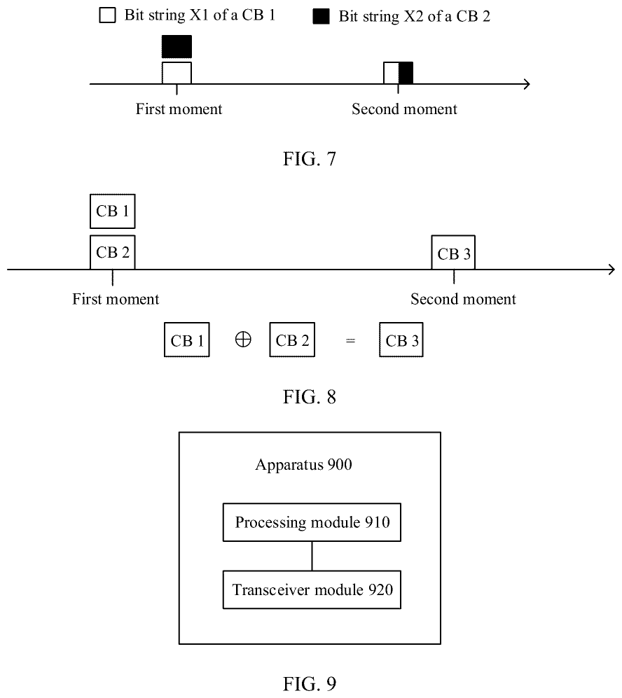

The following describes in detail the communication method provided in this embodiment of this application with reference to FIG. 7 and FIG. 8 by using an example in which two first CBs (that is, a to-be-transmitted TB is segmented into two second CBs) scheduled by using same DCI are mapped to a 16-QAM constellation diagram.

It should be understood that the CB scheduled by using the DCI may alternatively be a code block group (code block group, CBG). One code block group may include a plurality of code blocks.

FIG. 7 is a diagram of a code block transmission method according to an embodiment of this application. As shown in FIG. 7, at a first moment, a first communication device separately maps two first CBs (a bit string X1 of a first CB 1 and a bit string X2 of a first CB 2) to a constellation diagram of standard 16-QAM, to obtain a plurality of modulation symbols, and sends the obtained plurality of modulation symbols to a second communication device. Correspondingly, the second communication device receives initially transmitted data at the first moment, separately demodulates constellation diagrams of the two first CBs, and then separately performs decoding by using the demodulated data.

For the first CB and a to-be-transmitted TB, refer to related descriptions in the method 500. Details are not described herein again.

Optionally, a modulation scheme of each bit string may be another modulation scheme such as quadrature phase shift keying (quadrature phase shift keying, QPSK) or 64-QAM. It should be understood that different bit strings may use different modulation schemes, different bit rates, different transmission reliability requirements, different transmission bit error rate requirements, or different service types.

At a second moment, the first communication device selects half of bits from each of the bit strings X1 and X2 according to a first rule, then maps the half of bits of X1 and the half of bits of X2 to 16-QAM in a cascading manner according to a second rule, to obtain a modulation symbol, and sends the modulation symbol to the second communication device. Correspondingly, the second communication device receives retransmitted data at the second moment. When both X1 and X2 received at the first moment are correctly decoded, the second communication device no longer receives the retransmitted data. At the first moment, X1 is correctly decoded, and X2 is incorrectly decoded. In this case, the two cascading constellation diagrams are separately demodulated by using bit information of X1, and X2 is decoded by using demodulated soft information at the second moment and demodulated soft information at the first moment. At the first moment, X2 is correctly decoded, and X1 is incorrectly decoded. In this case, the two cascading constellation diagrams are separately demodulated by using bit information of X2, and X1 is decoded by using the demodulated soft information at the second moment and the demodulated soft information at the first moment. At the first moment, when X1 and the X2 are incorrectly decoded, the two cascading constellation diagrams are separately demodulated, and X1 and X2 are decoded by using the demodulated soft information at the second moment and the demodulated soft information at the first moment.

For the first rule and the second rule, refer to related descriptions in FIG. 3. Details are not described herein again.

Optionally, the first communication device and the second communication device may determine, in a protocol agreement manner or a signaling indication manner, whether the cascading transmission manner is used for retransmission, a specific retransmission in which the cascading transmission manner is used, or whether the cascading transmission manner is used for each time of retransmission. In other words, a specific time of retransmission in which the cascading transmission is used is not limited in this application. For example, in blind retransmission, the communication device may determine, based on factors such as a code length, a bit rate, and a decoding algorithm of channel encoding, a specific time of retransmission in which the cascading transmission manner is used. Alternatively, in a scenario in which there is an ACK/NACK feedback or there is only an ACK feedback, whether to use the cascading transmission manner may be determined based on a feedback status. For example, at a P^{th} moment, only one of the two first CBs is decoded correctly, and one of the two first CBs is decoded incorrectly. In this case, at a (P+1)^{th} moment, a transmit end uses a cascading transmission manner based on the feedback status.

It should be noted that the first moment and the second moment are two different moments, and the second moment is after the first moment. The first moment shown in FIG. 7 and the first moment shown in FIG. 3 are a same moment, and the second moment shown in FIG. 7 and the second moment shown in FIG. 3 are a same moment. Therefore, when the TB shown in FIG. 7 is not correctly demodulated at the first moment, there is a high probability that when the retransmitted data is received at the second moment, the TB is correctly demodulated, thereby effectively reducing a data transmission delay.

FIG. 8 is a diagram of another code block transmission method according to an embodiment of this application. As shown in FIG. 8, at a first moment, a first communication device separately maps two first CBs (a bit string X1 of a first CB 1 and a bit string X2 of a first CB 2) to a constellation diagram of standard 16-QAM, to obtain a plurality of modulation symbols, and sends the obtained plurality of modulation symbols to a second communication device. Correspondingly, the second communication device receives initially transmitted data at the first moment, separately demodulates the constellation diagrams of the two CBs, and then separately performs decoding by using the demodulated data.

For the first CB, refer to related descriptions in FIG. 7 and FIG. 8. Details are not described herein again.

At a second moment, the first communication device performs an exclusive OR operation on the bit string X1 and the bit string X2, to obtain a bit string X3, then maps the bit string X3 to a 16-QAM constellation diagram, to obtain a plurality of modulation symbols, and sends the plurality of modulation symbols to the second communication device. Correspondingly, the second communication device receives retransmitted data at the second moment. When both X1 and X2 received at the first moment are correctly decoded, the second communication device no longer receives the retransmitted data. When X1 received at the first moment is correctly decoded and X2 is incorrectly decoded, X3 is demodulated and decoded, and X2 is decoded through an exclusive OR operation by using bit information of X1. When X2 received at the first moment is correctly decoded and X1 is incorrectly decoded, X3 is demodulated and decoded, and X1 is decoded through an exclusive OR operation by using bit information of X2. When both X1 and X2 received at the first moment are incorrectly decoded, decoding is abandoned.

It should be noted that the first moment and the second moment are two different moments, and the second moment is after the first moment.

According to an exclusive OR encoding manner provided in this application, when a quantity of transmission times is fixed, resources occupied by retransmission can be reduced; or when a quantity of resources occupied by transmission is fixed, a quantity of transmission times is increased, to improve link reliability.

Optionally, if a quantity of retransmission times is greater than 1, retransmission may be performed in the foregoing exclusive OR manner for different times of retransmission, or retransmission is performed in a cascading transmission manner for different times of retransmission. Alternatively, different times of retransmission are performed in different manners. For example, one time of retransmission uses cascading transmission, and another time of retransmission uses exclusive OR transmission. In addition, a specific time of retransmission that uses exclusive OR transmission is not limited in this application.

It should be noted that a multi-transmission manner may alternatively be used in different transmission modes, for example, a grant free (Grant free) transmission mode, a multislot (slot) aggregation transmission mode, another transmission mode, or a combination of transmission modes. In addition, in a same transmission mode, service types may be different.

It should be understood that, in FIG. 7 and FIG. 8, a quantity of first CBs scheduled by one piece of DCI may alternatively be 2n (n is an integer greater than 0), and the 2n first CBs are all determined based on the to-be-transmitted TB.

It should be further understood that sequence numbers of the foregoing processes do not mean an execution order. The execution order of the processes should be determined based on functions and internal logic of the processes, and should not be construed as any limitation on implementation processes of embodiments of this application.

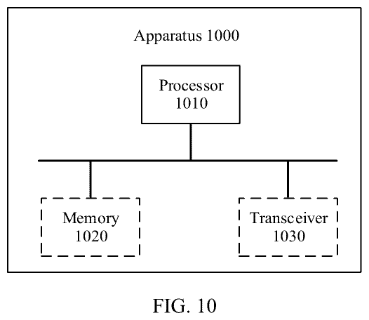

The foregoing describes in detail the communication method in embodiments of this application with reference to FIG. 3 to FIG. 8. The following describes in detail a communication apparatus in embodiments of this application with reference to FIG. 9 and FIG. 10.

FIG. 9 shows a communication apparatus 900 according to an embodiment of this application. As shown in FIG. 9, the communication apparatus 900 includes a processing module 910 and a transceiver module 920.

In a possible implementation, the communication apparatus 900 is the first communication device (a terminal or a network device) or a chip of the first communication device.

The processing module 910 is configured to: determine a first target transport block TB, where the first target TB includes at least one modulation symbol, the at least one modulation symbol is obtained by modulating one bit group by using a first modulation scheme, the bit group includes at least one bit of each of at least two first code blocks CBs, and the at least two first CBs are determined based on a to-be-transmitted TB. The transceiver module 920 is configured to send the first target TB.

Optionally, the bit group includes at least one bit of each first CB in one first CB group, and the one first CB group includes at least two different first CBs.

Optionally, the processing module 910 is further configured to group the at least two first CBs to obtain at least one first CB group.

Optionally, the at least two first CBs are obtained by encoding the at least two second CBs. The processing module 910 is further configured to segment the to-be-transmitted TB into the at least two second CBs when a length of the to-be-transmitted TB is greater than or equal to a segmentation threshold, where the segmentation threshold is less than a preset segmentation length of channel encoding.

Optionally, the segmentation threshold is agreed on in a protocol, or is indicated by signaling.

Optionally, the at least two first CBs are obtained by encoding the at least two second CBs. The processing module 910 is further configured to: when the length of the to-be-transmitted TB is less than the preset segmentation length of channel encoding, segment the to-be-transmitted TB into two second CBs; or when the length of the to-be-transmitted TB is greater than or equal to the preset segmentation length of channel encoding, segment the to-be-transmitted TB into 2n second CBs, where n is an integer greater than 0.

Optionally, a quantity of second CBs is the same as a quantity of first CBs, one first CB corresponds to one second CB, different first CBs correspond to different second CBs, and each of the at least two first CBs includes a bit corresponding to a first redundancy version obtained by encoding a corresponding second CB.

Optionally, the first redundancy version is determined based on a quantity of transmission times, an initial transmission bit rate, and a mapping relationship, and the mapping relationship indicates a correspondence between a redundancy version transmission sequence and a bit rate threshold.

Optionally, at least two different first CBs included in any first CB group meet at least one of the following: different bit rates, different transmission reliability requirements, different transmission bit error rate requirements, or different service types.

Optionally, when there are a plurality of first CB groups, modulation schemes used by at least two of the plurality of first CB groups are different.

Optionally, the transceiver module 920 is further configured to send a second target TB on the time frequency resource, where at least two of the plurality of modulation symbols are obtained by modulating different first CBs.

Optionally, the different first CBs meet at least one of the following: different bit rates, different modulation schemes used for transmission, different transmission reliability requirements, different transmission bit error rate requirements, or different service types.

Optionally, the transceiver module 920 is further configured to receive or send first information, where the first information indicates the first modulation scheme.

In an optional example, a person skilled in the art may understand that the communication apparatus 900 may be specifically the first communication device in the foregoing embodiments, and the communication apparatus 900 may be configured to perform procedures and/or steps corresponding to the first communication device in the method 500. To avoid repetition, details are not described herein again.

In another possible implementation, the communication apparatus 900 is the second communication device (a terminal or a network device) or a chip of the second communication device.

The transceiver module 920 is configured to: receive a first target TB, where the first target TB includes at least one modulation symbol, the at least one modulation symbol is obtained by modulating one bit group by using a first modulation scheme, the bit group includes at least one bit of each of at least two first CBs, and the at least two first CBs are determined based on a to-be-transmitted TB. The processing module 910 is configured to demodulate the first target TB.

Optionally, the one bit group includes at least one bit of each first CB in one first CB group, and the one first CB group includes at least two different first CBs.

Optionally, the first CB group is obtained by grouping the at least two first CBs.

Optionally, the at least two first CBs are obtained by encoding at least two second CBs, and the at least two second CBs are obtained by segmenting the to-be-transmitted TB.

Optionally, a quantity of second CBs is determined based on a value relationship between a length of the to-be-transmitted TB and a segmentation threshold, and the segmentation threshold is agreed on in a protocol, or is indicated by signaling.

Optionally, a quantity of second CBs is determined based on a value relationship between a length of the to-be-transmitted TB and a preset segmentation length of channel encoding.

Optionally, a quantity of second CBs is the same as a quantity of first CBs, one first CB corresponds to one second CB, different first CBs correspond to different second CBs, and each of the at least two first CBs includes a bit corresponding to a first redundancy version obtained by encoding a corresponding second CB.

Optionally, the first redundancy version is determined based on a quantity of transmission times, an initial transmission bit rate, and a mapping relationship, and the mapping relationship indicates a correspondence between a redundancy version transmission sequence and a bit rate threshold.

Optionally, at least two different first CBs included in any first CB group meet at least one of the following: different bit rates, different transmission reliability requirements, different transmission bit error rate requirements, or different service types.

Optionally, when there are a plurality of first CB groups, modulation schemes used by at least two of the plurality of first CB groups are different.

Optionally, the transceiver module 920 is further configured to receive a second target TB, where the second target TB includes a plurality of modulation symbols, and at least two of the plurality of modulation symbols are obtained by modulating different first CBs. The processing module 910 is further configured to demodulate the second target TB.

Optionally, the transceiver module 920 is further configured to receive the second target TB on a time frequency resource, where modulation symbols corresponding to the different first CBs occupy different frequency domain resources and/or different time domain resources.

Optionally, the different first CBs meet at least one of the following: different bit rates, different modulation schemes used for transmission, different transmission reliability requirements, different transmission bit error rate requirements, or different service types.

Optionally, the transceiver module 920 is further configured to receive or send first information, where the first information indicates the first modulation scheme.

In an optional example, a person skilled in the art may understand that the communication apparatus 900 may be specifically the second communication device in the foregoing embodiments, and the communication apparatus 900 may be configured to perform procedures and/or steps corresponding to the second communication device in the method 500. To avoid repetition, details are not described herein again.

It should be understood that the communication apparatus 900 herein is embodied in a form of a functional module. The term “module” herein may be an application-specific integrated circuit (application-specific integrated circuit, ASIC), an electronic circuit, a processor (for example, a shared processor, a dedicated processor, or a group processor) configured to execute one or more software or firmware programs, a memory, a merged logic circuit, and/or another appropriate component that supports the described function. In an optional example, a person skilled in the art may understand that the communication apparatus 900 may be specifically the first communication device or the second communication device in the foregoing embodiments, or functions of the first communication device or the second communication device in the foregoing embodiments may be integrated into the communication apparatus 900. The communication apparatus 900 may be configured to perform procedures and/or steps corresponding to the first communication device or the second communication device in the foregoing method embodiments. To avoid repetition, details are not described herein again.

The communication apparatus 900 has a function of implementing corresponding steps performed by the data processing device in the foregoing method. The foregoing functions may be implemented by hardware, or may be implemented by hardware executing corresponding software. The hardware or the software includes one or more modules corresponding to the function. For example, the transceiver module 920 may be a communication interface, for example, a transceiver interface.

FIG. 10 shows another communication apparatus 1000 according to an embodiment of this application. The communication apparatus 1000 includes a processor 1010. Optionally, the apparatus 1000 further includes a memory 1020 and a transceiver 1030. The processor 1010, the memory 1020, and the transceiver 1030 are connected through an internal connection path. The memory 1020 is configured to store instructions. The processor 1010 is configured to execute the instructions stored in the memory 1020, so that the communication apparatus 1000 can perform the communication method provided in the foregoing method embodiments.

It should be understood that functions of the communication apparatus 1000 in the foregoing embodiments may be integrated into the communication apparatus 1000, and the communication apparatus 1000 may be configured to perform the steps and/or procedures corresponding to the first communication device in the foregoing method embodiments. Alternatively, the communication apparatus 1000 may be further configured to perform steps and/or procedures corresponding to the second communication device in the foregoing method embodiments. Optionally, the memory 1020 includes a read-only memory and a random access memory, and provide instructions and data to the processor. A part of the memory may further include a non-volatile random access memory. For example, the memory may further store information of a device type. The processor 1010 may be configured to execute the instructions stored in the memory. When the processor executes the instructions, the processor 1010 may perform the steps and/or procedures corresponding to the first communication device in the foregoing method embodiments. Alternatively, the processor 1010 may perform steps and/or procedures corresponding to the second communication device in the foregoing method embodiments.

It should be understood that, in this embodiment of this application, the processor 1010 may be a central processing unit (central processing unit, CPU) or a baseband processor, or the processor 1010 may be another general-purpose processor, a digital signal processor (digital signal process, DSP), an ASIC, a field programmable gate array (field programmable gate array, FPGA) or another programmable logic device, a discrete gate or a transistor logic device, a discrete hardware component, or the like. The processor 1010 may be a microprocessor or the processor 1010 may be any conventional processor or the like.

In an implementation process, steps in the method 200 can be implemented by using a hardware integrated logical circuit in the processor, or by using instructions in a form of software. The steps of the method disclosed with reference to embodiments of this application may be directly performed by a hardware processor, or may be performed by using a combination of hardware in the processor and a software module. A software module may be located in a mature storage medium in the art, such as a random access memory, a flash memory, a read-only memory, a programmable read-only memory, an electrically erasable programmable memory, or a register. The storage medium is located in the memory, and a processor reads instructions in the memory and completes the steps in the foregoing methods in combination with hardware of the processor. To avoid repetition, details are not described herein again.

This application further provides a computer-readable medium storing a computer program. When the computer program is executed by a computer, functions of any one of the foregoing method embodiments are implemented.

This application further provides a computer program product including instructions. When the computer program product is executed by a computer, a function in any one of the foregoing method embodiments is implemented.

A person of ordinary skill in the art may be aware that, in combination with the examples described in embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and module, refer to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of this application essentially, or the part contributing to some embodiments, or some of the technical solutions may be implemented in a form of a software product. The computer software product is stored in a storage medium, and includes several instructions for instructing a computer device (which may be a personal computer, a server, or a network device) to perform all or some of the steps of the methods described in embodiments of this application. The foregoing storage medium includes any medium that can store program code, such as a USB flash drive, a removable hard disk, a read-only memory (read-only memory, ROM), a random access memory (random access memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A communication method, comprising:
determining a first target transport block TB, wherein the first target TB comprises at least one modulation symbol, the at least one modulation symbol is obtained by modulating one bit group by using a first modulation scheme, the bit group comprises at least one bit of each of at least two first code blocks CBs, and the at least two first CBs are determined based on a to-be-transmitted TB; and
sending the first target TB.

2. The method according to claim 1, wherein the bit group comprises at least one bit of each first CB in one first CB group, and the one first CB group comprises at least two different first CBs.

3. The method according to claim 2, wherein the at least two first CBs are obtained by encoding at least two second CBs, and the method further comprises:
segmenting the to-be-transmitted TB into the at least two second CBs when a length of the to-be-transmitted TB is greater than or equal to a segmentation threshold, wherein the segmentation threshold is less than a preset segmentation length of channel encoding; or
segmenting the to-be-transmitted TB into two second CBs when a length of the to-be-transmitted TB is less than a preset segmentation length of channel encoding; or
segmenting the to-be-transmitted TB into 2n second CBs when a length of the to-be-transmitted TB is greater than or equal to a preset segmentation length of channel encoding, wherein n is an integer greater than 0.

4. The method according to claim 3, wherein a quantity of second CBs is the same as a quantity of first CBs, one first CB corresponds to one second CB, different first CBs correspond to different second CBs, and each of the at least two first CBs comprises a bit corresponding to a first redundancy version obtained by encoding a corresponding second CB.

5. The method according to claim 2, wherein the at least two different first CBs comprised in the first CB group meet at least one of the following:
different bit rates, different transmission reliability requirements, different transmission bit error rate requirements, or different service types.

6. The method according to claim 2, wherein when there are a plurality of first CB groups, modulation schemes used by at least two of the plurality of first CB groups are different.

7. The method according to claim 1, wherein the method further comprises:
determining a second target TB, wherein the second target TB comprises a plurality of modulation symbols, and at least two of the plurality of modulation symbols are obtained by modulating different first CBs; and
sending the second target TB.

8. The method according to claim 7, wherein the different first CBs meet at least one of the following: different bit rates, different modulation schemes used for transmission, different transmission reliability requirements, different transmission bit error rate requirements, or different service types.

9. A communication method, comprising:
receiving a first target TB, wherein the first target TB comprises at least one modulation symbol, the at least one modulation symbol is obtained by modulating one bit group by using a first modulation scheme, the bit group comprises at least one bit of each of at least two first CBs, and the at least two first CBs are determined based on a to-be-transmitted TB; and
demodulating the first target TB.

10. The method according to claim 9, wherein the bit group comprises at least one bit of each first CB in one first CB group, and the one first CB group comprises at least two different first CBs.

11. The method according to claim 10, wherein the at least two first CBs are obtained by encoding at least two second CBs, and the at least two second CBs are obtained by segmenting the to-be-transmitted TB.

12. The method according to claim 11, wherein a quantity of second CBs is determined based on a value relationship between a length of the to-be-transmitted TB and a segmentation threshold, and the segmentation threshold is agreed on in a protocol or indicated by signaling; or
a quantity of second CBs is determined based on a value relationship between a length of the to-be-transmitted TB and a preset segmentation length of channel encoding.

13. The method according to claim 10, wherein the at least two different first CBs comprised in the first CB group meet at least one of the following:
different bit rates, different transmission reliability requirements, different transmission bit error rate requirements, or different service types.

14. The method according to claim 10, wherein when there are a plurality of first CB groups, modulation schemes used by at least two of the plurality of first CB groups are different.

15. The method according to claim 9, wherein the method further comprises:
receiving a second target TB, wherein the second target TB comprises a plurality of modulation symbols, and at least two of the plurality of modulation symbols are obtained by modulating different first CBs; and
demodulating the second target TB.

16. A communication apparatus, comprising: at least one processor coupled to at least one memory storing a computer program including instructions that, when executed by the processor, cause the communication apparatus to perform:
determining a first target transport block TB, wherein the first target TB comprises at least one modulation symbol, the at least one modulation symbol is obtained by modulating one bit group by using a first modulation scheme, the bit group comprises at least one bit of each of at least two first code blocks CBs, and the at least two first CBs are determined based on a to-be-transmitted TB; and
sending the first target TB.

17. The communication apparatus according to claim 16, wherein the bit group comprises at least one bit of each first CB in one first CB group, and the one first CB group comprises at least two different first CBs.

18. The communication apparatus according to claim 17, wherein the at least two first CBs are obtained by encoding at least two second CBs, and wherein when the instructions are executed by the processor, further cause the communication apparatus to perform:
segmenting the to-be-transmitted TB into the at least two second CBs when a length of the to-be-transmitted TB is greater than or equal to a segmentation threshold, wherein the segmentation threshold is less than a preset segmentation length of channel encoding; or
segmenting the to-be-transmitted TB into two second CBs when a length of the to-be-transmitted TB is less than a preset segmentation length of channel encoding; or
segmenting the to-be-transmitted TB into 2n second CBs when a length of the to-be-transmitted TB is greater than or equal to a preset segmentation length of channel encoding, wherein n is an integer greater than 0.

19. The communication apparatus according to claim 17, wherein when there are a plurality of first CB groups, modulation schemes used by at least two of the plurality of first CB groups are different.

20. The communication apparatus according to claim 16, wherein when the instructions are executed by the processor, further cause the communication apparatus to perform:
determining a second target TB, wherein the second target TB comprises a plurality of modulation symbols, and at least two of the plurality of modulation symbols are obtained by modulating different first CBs; and
sending the second target TB.
